(19) United States
(12) Patent Application Publication
(10) Pub. No.: US 2016/0136522 A1
(43) Pub. Date: May 19, 2016

(54) SYSTEM FOR UPGRADING AND SCREENING OF TASK AND ITS IMPLEMENTING METHOD

(71) Applicant: UNIQUE MONSTER CO., LTD., TAIPEI CITY (TW)

(72) Inventors: CHUNG YEN HSU, TAIPEI CITY (TW); MING CHE LIN, TAIPEI CITY (TW)

(21) Appl. No.: 14/933,783

(22) Filed: Nov. 5, 2015

(30) Foreign Application Priority Data
Nov. 14, 2014 (TW) 103139636

(51) Int. Cl. A63F 13/42; G06F 3/0482; H04W 4/02; A63F 13/92

(52) U.S. Cl. CPC A63F 13/42; A63F 13/92; G06F 3/0482; H04W 4/023

(57) ABSTRACT

A system for upgrading and screening of task and its implementing method is provided, which is mainly formed by at least one mobile information device and a task database. The task database receives a creation application of a task stronghold submitted from the mobile information device. After the creation of a task stronghold is completed, each task stronghold of a task database is triggered by the mobile information device so as to perform the task. If two adjacent task strongholds in the creation of a task stronghold have their respective task trade-off ranges overlapped each other, the task database performs screening of the task strongholds so as to maintain the number of tasks and participation rate in best condition.

### BACKGROUND OF INVENTION

1. Field of the Invention

The present invention relates to a system for upgrading and screening of task and its implementing method, more particularly to a system for upgrading and screening of task and its implementing method, wherein, if two adjacent task strongholds have their respective task trade-off ranges overlapped with each other, the task stronghold with lower trade-off parameter can be deleted or hidden by a trade-off parameter so as to maintain the number of task stronghold and participation rate in best condition.

2. Brief Description of Prior Art

Accompanying with the popularity of smart phones and wireless network, the applications associated therewith are also increased. Currently, there is a business model in which augmented reality game is combined together so as to achieve the purpose of allowing players to go outside and to collect at a place of the same real world. Therefore, merchant can gather game players in a fixed point of product sales held by the merchant through augmented reality games, so as to achieve the effect of promotional activities and gathering crowd. Referring to a Taiwanese Patent Gazette No. 1300720 entitled “Network Game of Real World”, an online network game with the real world as the performance venue is mainly disclosed. A host machine can be set with a real world (for example, real Taipei city) as the game venue, players get online network game identity after host logon and install necessary programs into their portable devices. When playing the game using the portable device, players can manipulate the identity logged on the online game so as to perform the game in real world (for example, real Taipei city). The portable device can backhaul the player's location and game information to the host server through wireless networking and satellite positioning function so that the host machine can get player's true position and allow the game logged identity to be positioned in the same location as the online network game venue (online Taipei city) so as to perform online network game. However, the venue of conventional online network game has no screening function, when the number of venue becomes more and more, the players in the region may be dispersed to various online network games, so that participants in each task is low and playing interest of players is thus reduced. Alternatively, player may be dispatched to the task having few participants, so he may decide not to play online network game anymore due to lack of interaction in task. Therefore, this sort of online network game should have task screening function so as to increase overall playability. There are other references of prior art list as below:
(1) Taiwanese Patent Gazette No. 1395149 entitled “System and method for computing degree of business activities”
(2) Taiwanese Invention Publication No. 200842748 entitled “System and operational method of combining electronic map virtual roaming and promotional advertisement”
(3) Taiwanese Invention Publication No. 201217999 entitled “Method and apparatus for capturing ambient scenario”
(4) China Invention Patent No. 101553290 entitled “System and method for managing a virtual world mapped to the real position in a macro-scale multiplayer online role-playing game MMORPG”
(5) China Invention Patent CN 100522301C entitled “Positioning information-linked game system and its method”
(6) US Patent US20130262203 entitled “Location-based task and game functionality”

### SUMMARY OF THE INVENTION

In view of the above problems, the inventor of the present invention has conducted research and analysis on method and system of current augmented reality game, based on his abundant experience in relevant field and product design, in order to bring about a better game system. Therefore, the main object of the present invention is to provide a system for upgrading and screening of task and its implementing method, in which a task database can automatically screen two adjacent task strongholds having their respective task trade-off ranges overlapped with other, so as to delete or hide the task stronghold with lower trade-off parameter.
In order to achieve above object, the present invention is mainly formed by at least one mobile information device and a task database. The mobile information device is used for creating a task or performing a task execution program. If user chooses to create a task, he or she can input a task content and transfer it to a game server, and save a task information of a task in a task database, and issue the task information to the other mobile information devices or interne so that other users can also get the task information synchronously. Alternatively, if user wants to perform a task, he or she has to allow his or her mobile information device to enter into a task trade-off range so as to perform the task. If two or more tasks have their trade-off ranges overlapped with each other, the task database will compare trade-off parameters of the two tasks and delete or hide the task stronghold having lower trade-off parameter so as to maintain a certain number of participants in each task, and screen the task having lower participants such that new created task can become easily noticeable and increase rapidly its participation rate and popularity. Furthermore, since users have to move into the task trade-off range so as to be allowed to perform the task, gaming community effect can be established in addition to the aggregation of users, and the task information can carry business messages such as store sales, exhibition messages, department store anniversary celebration messages, group activities, products promotional messages to each user. Therefore, the task information has effect of pushing message.

The object, technical features and effect of implementation of the present invention will become more apparent by the detailed description of the following embodiment in conjunction with accompanying drawings, in which:

### BRIEF DESCRIPTION OF THE DRAWINGS

FIG. 1 is a system frame structure (I) of the present invention;

FIG. 2 is a system frame structure (II) of the present invention;

FIG. 3 is the implementing method of the present invention;

FIG. 4 is a schematic view (I) of the implementation of the present invention;

FIG. 5 is a detailed flow chart of the task creation steps of the present invention;

FIG. 6 is a schematic view (II) of the implementation of the present invention;

FIG. 7 is a schematic view (III) of the implementation of the present invention;

FIG. 8 is a schematic view (IV) of the implementation of the present invention;

FIG. 9 is a schematic view (V) of the implementation of the present invention;

FIG. 10 is a detailed flow chart of the task execution steps of the present invention;

FIG. 11 is a schematic view (VI) of the implementation of the present invention;

FIG. 12 is a schematic view (VII) of the implementation of the present invention;

FIG. 13 is a schematic view (VIII) of the implementation of the present invention;

FIG. 14 is a schematic view (IX) of the implementation of the present invention.

### DETAILED DESCRIPTION OF PREFERRED EMBODIMENTS

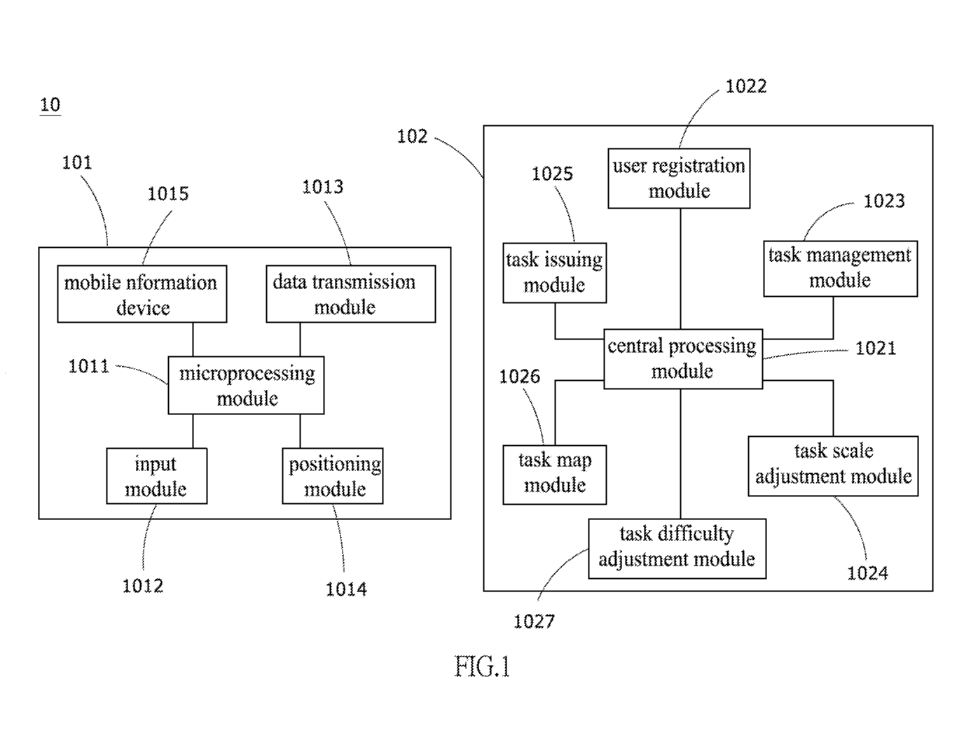

FIG. 1 is a system frame structure (I) of the present invention. As shown in the figure, the system 10 for upgrading and screening of task of the present invention is mainly formed by at least one mobile information device 101 and a task database 102. The mobile information device 101 has a microprocessing module 1011, and additionally has an input module 1012, a data transmission module 1013, a positioning module 1014 and a task execution program 1015 in information connection with the microprocessing module 1011. The microprocessing module 1011 can be a microcontroller unit; the input module 1012 can be a touch screen or a entity keyboard for user to operate the task execution program 1015, the execution result of which can be shown on a screen (not shown) of the mobile information device 101; the data transmission module 1013 can be wireless fidelity (wi-fi), Bluetooth, 2.4G, mobile communication technique etc., and the data transmission module 1013 is in information connection with the task database 102; the positioning module 1014 is used for positioning the instantaneous position of the mobile information device 101 and thus to produce a instantaneous position information, which can be global positioning system (GPS); the task executing program 1015 can be preloaded on the mobile information device 101, or downloaded into the mobile information device 101 through interne and further installed into the mobile information device 101, the task executing program 1015 being used for users to create or execute a task; the task database 102 has a central processing module 1021, and additionally has an user registration module 1022, a task management module 1023, a task scale adjustment module 1024, a task issuing module 1025, a task map module 1026, and a task difficulty adjustment module 1027 in information connection with the central processing module 1021; the central processing module 1021 can be a central processing unit for transmitting and processing data between the modules; the user registration module 1022 is used for saving user's identity information and user's initial location information; the task management module 1023 is used for managing the creation or execution of a task and further for screening a task having its task trade-off range overlapped with that of the other task; the task scale adjustment module 1024 is used for adjusting the task trade-off range of a task; the task issuing module 1025 is in information connection with the data transmission module 1013 of the mobile information device 101 so that the task after creation is issued to the mobile information device 101 through interne; the task map module 1026 has a plurality of digital map data, by which user's instantaneous location and task position can be marked on the digital map data, and is further displayed on the mobile information device 101 for other users to view; the task difficulty adjustment module 1027 is used for adjusting the task difficulty of a task.

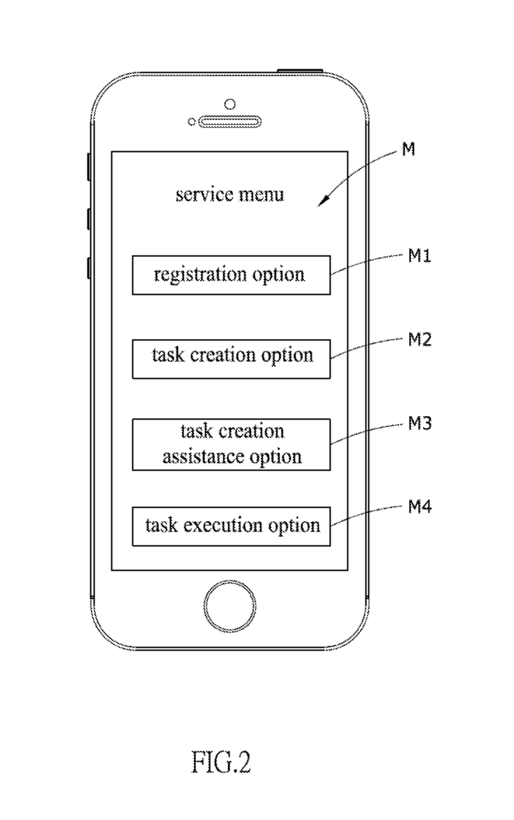

FIG. 2 is a system frame structure (II) of the present invention. As shown in FIGS. 1 and 2, after user performs the task execution program 1015 on the mobile information device 101, the data transmission module 1013 of the mobile information device 101 is actuated so that the data transmission module 1013 finishes information connection with the task issuing module 1025 of the task database 102, and then a service menu M is generated on the mobile information device 101. The service menu M comprises a registration option M1, a task creation option M2, a task creation assistance option M3 and a task execution option M4. However, service options in the service menu M can be increased or decreased depending on actual application status, and is not limited thereto.

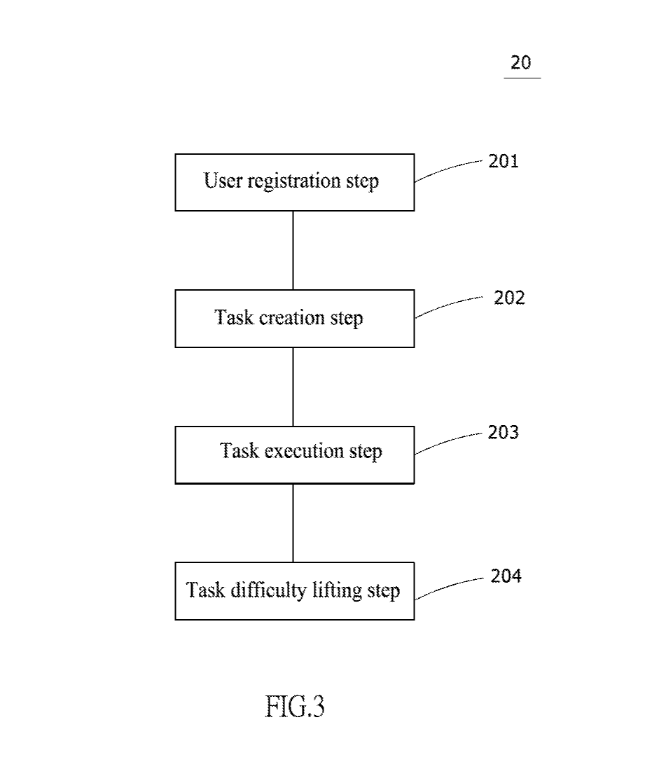

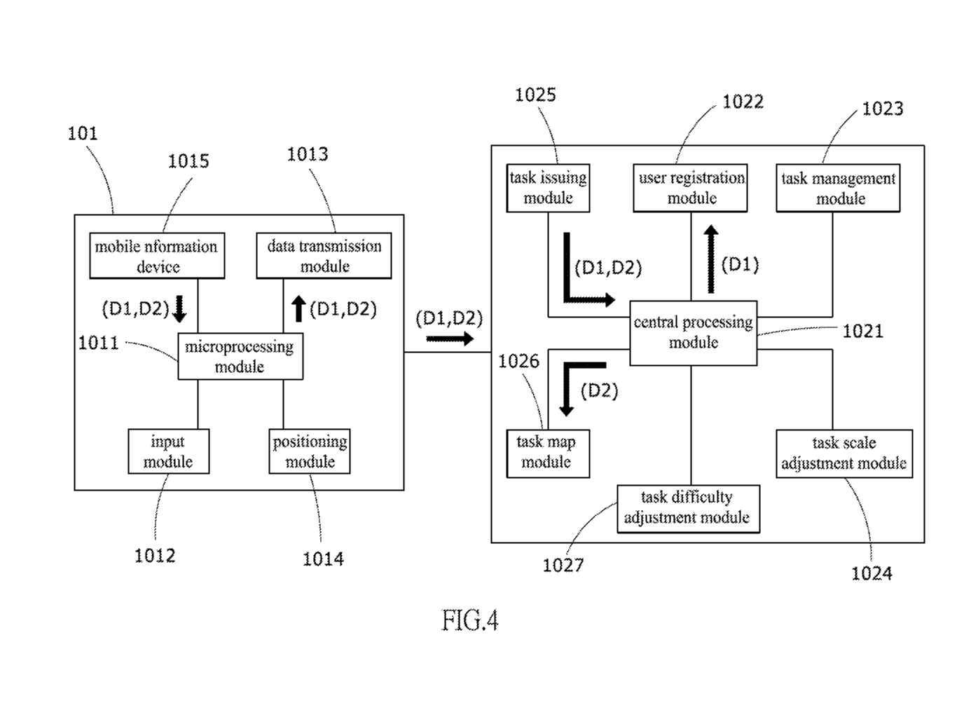

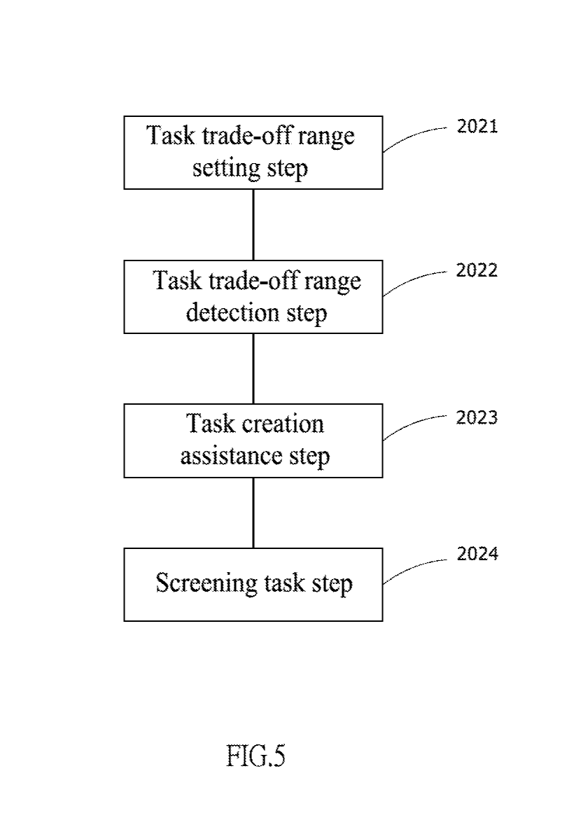

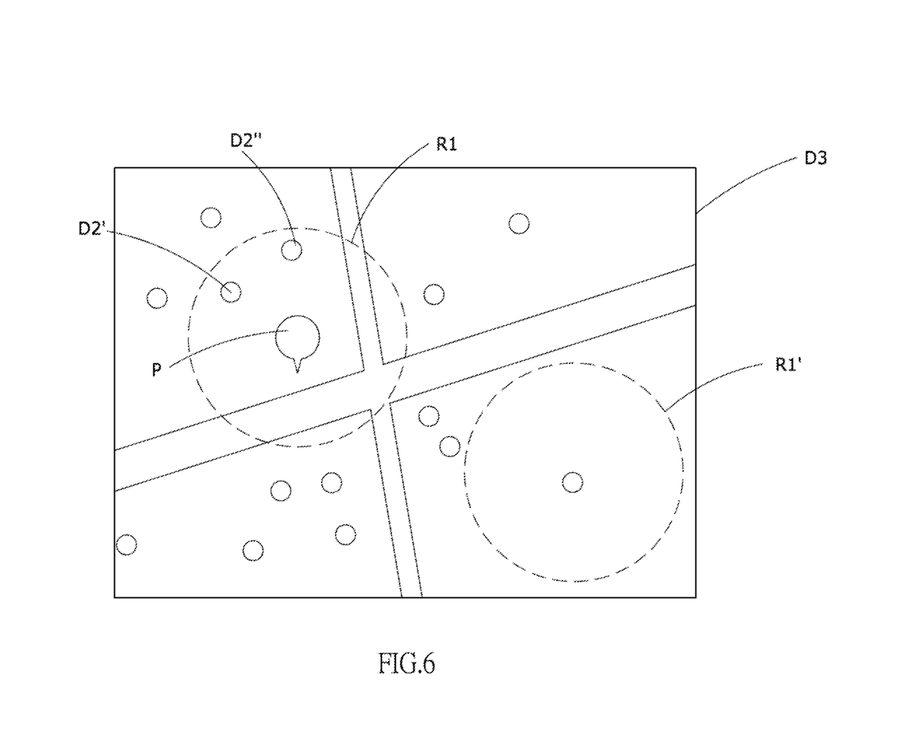

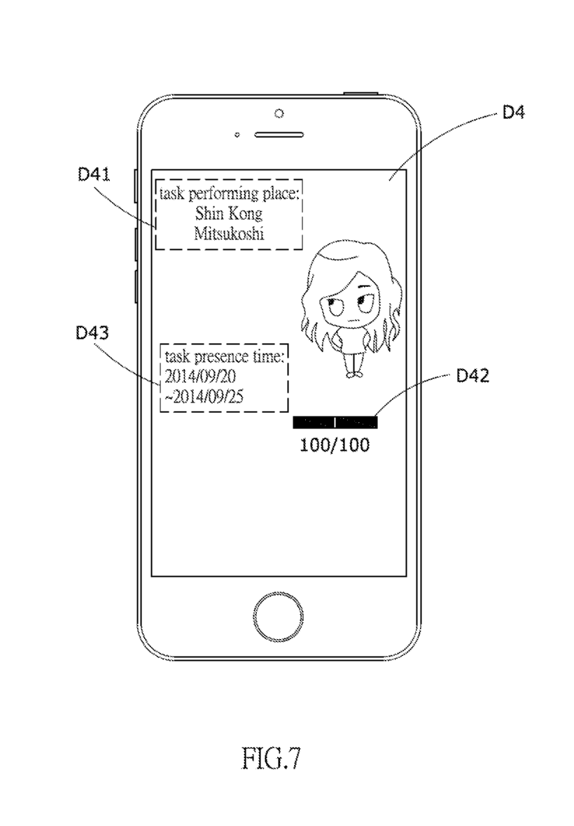

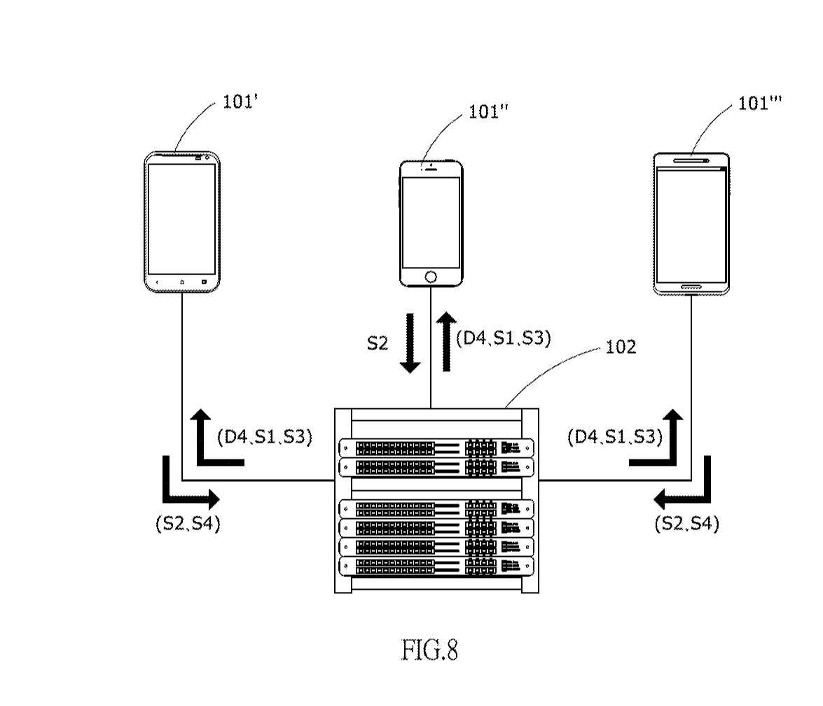

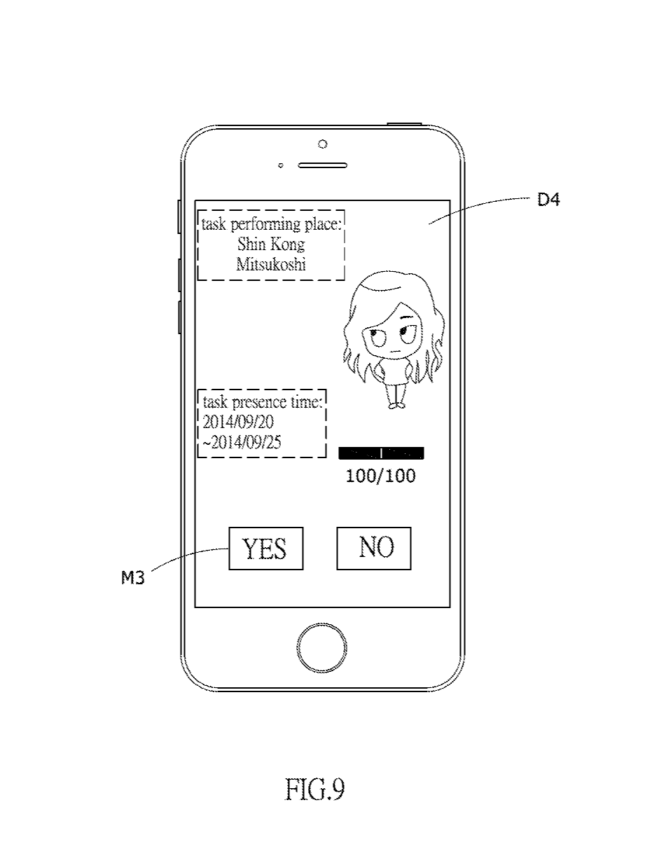

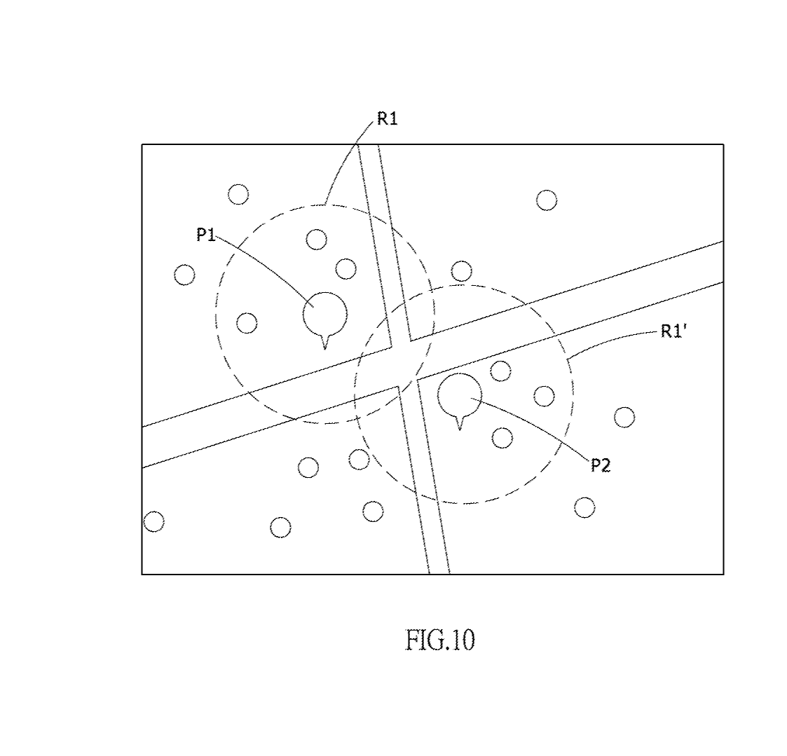

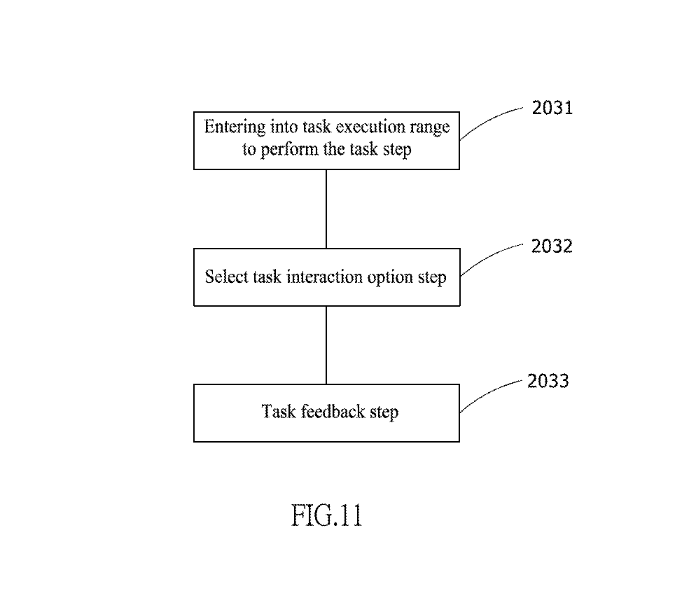

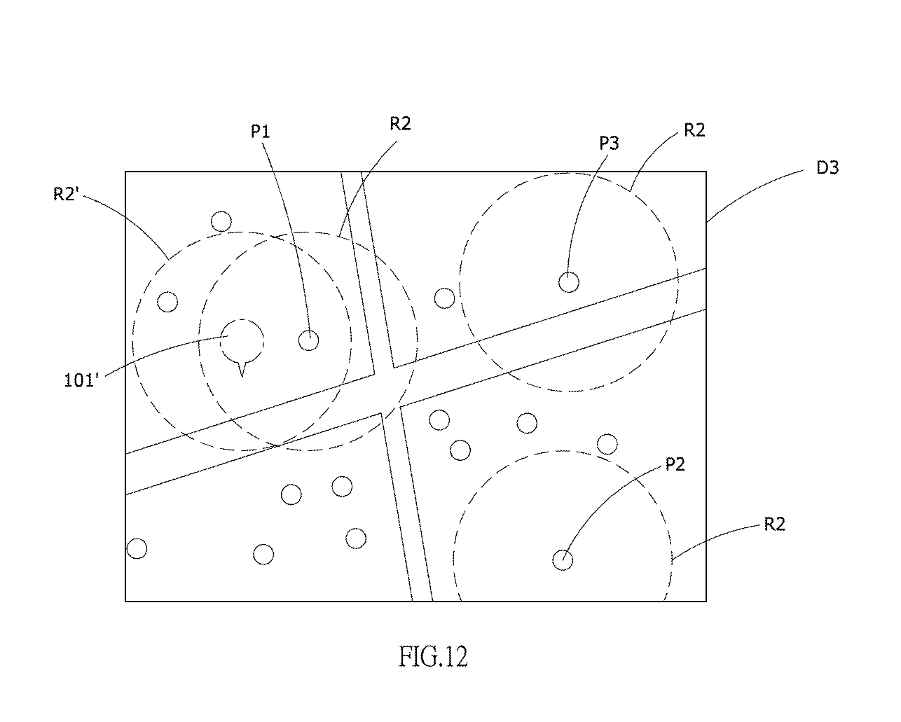

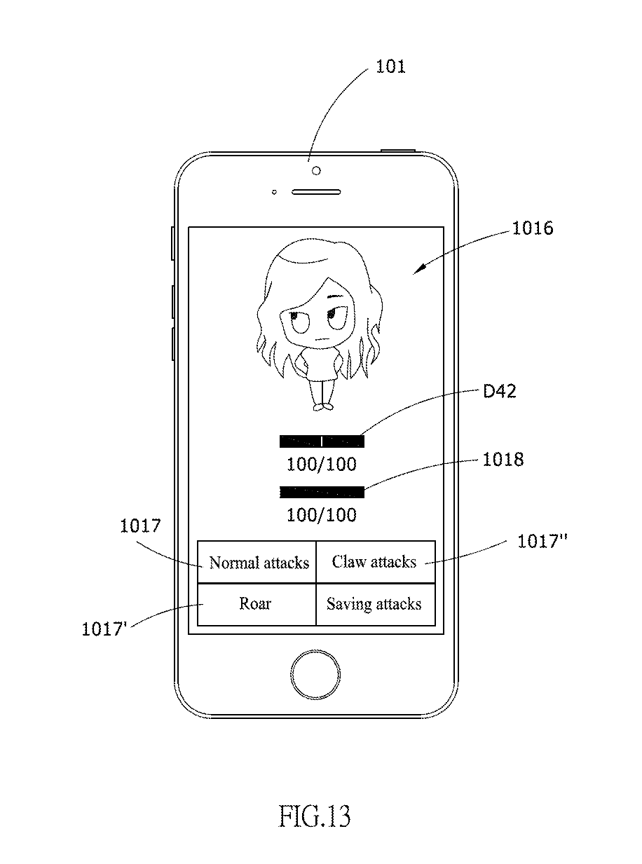

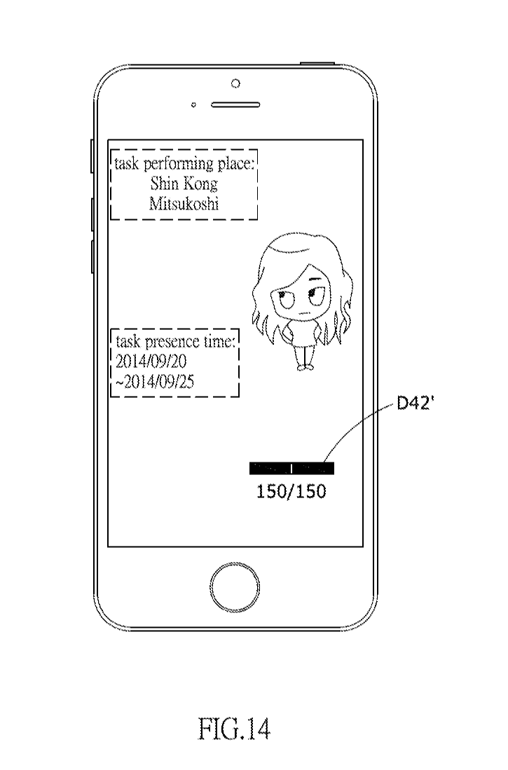

FIG. 3 is the implementing method of the present invention; and FIG. 4˜14 are schematic views (I)˜(IX) of the implementation of the present invention. As shown in these figures, the steps of the implementing method 20 of the system for upgrading and screening of task will be described as below:
(1) User registration step 201: also referring to FIG. 4, after user clicks the registration option M1 of the service menu M (as shown in FIG. 2), the user can input a user's identity data and a user's initial location data by the input module 1012 of the mobile information device 101. The user's identity data may include user name, user gender, user constellation, user profile etc., while user's initial location data may include, for example, user communication address (No.xx, section xx, road xx, Taipei city). The user's initial location data can also be retrieved from the location coordinates of the user through the automatic positioning of the positioning module 1014, or the task execution program 1015 actively retrieves user's identity data within the other program in the mobile information device 101. The above ways that the mobile information device 101 actively records the user's location information with the positioning module 1014 is the embodiment of program active input. However, it is noted here that any one way enabling the retrieve of user's relevant information is also available, not limited to manual input. Moreover, when the task execution program 1015 gets user's identity data and user's initial location data, the task execution program 1015 will generate a user registration information D1 and a user registration location information D2, and both information D1 and D2 are transmitted to the task database 102 by the data transmission module 1013. The user registration information D1 is then saved in the user registration module 1022 and the user registration location information D2 is saved in the task map module 1026 by the central processing module 1021 of the task database 102. After saving is completed, user registration is finished.
(2) Task creation step 202: FIG. 5 is a detailed flow chart of the task creation step of the present invention. The task creation step 202 includes following steps.
   1. Task trade-off range setting step 2021: also referring to FIG. 6, after user finishes the registration of clicking the task creation option M2 (as shown in FIG. 2), user can assign anyone location of the task map module 1026 as a task stronghold P of the task. When the assignment of the task stronghold P is finished, the task scale adjustment module 1024 of the task database 102 will retrieve user registration location information (D2′,D2″ . . . ) within a certain range (such as 500 meters) around the task stronghold P, and a task trade-off range R1 is extended outward with the task stronghold P as the center. The task scale adjustment module 1024 can adjust the range of the task trade-off range R1 by a first trade-off parameter, wherein the first trade-off parameter can be the number of user registration location information (D2′,D2″ . . .) within a certain range and the population within a certain range of user instantaneous location that can be detected by the task scale adjustment module 1024, or the number of users registered within a certain range of that location detected, or the instantaneous number of users within a certain range of that location, or the actual world population data within a certain range of that location, for trade-off operation, but is not limited thereto. For example, the less the number of user registration location information D2 is, the larger the task trade-off range R1 is adjusted by the task scale adjustment module 1024. On the contrary, the smaller the task trade-off range R1 is adjusted by the task scale adjustment module 1024.
   2. Task trade-off range detection step 2022: after the setting of the task trade-off range R1 is completed, the task stronghold P will be shown on the task map module 1026. At this moment, the task management module 1023 will detect whether the task trade-off range R1 of the task is overlapped with the task trade-off range R1′ of the other task or not. If the detection result of the task management module 1023 is “not overlapped”, user can input a task creation information in the task stronghold P by the input module 1012, and the microprocessing module 1011 will transmit the task creation information to the task database 102 by the data transmission module 1013 and a task creation assistance step 2023 is performed, wherein the task creation information may at least includes a task name, a description of task content which can be filled with store sales message, exhibition activity message, department store anniversary celebration message, group activities, product promotion message, so as to push business information to the other mobile information devices. If the detection result of the task management module 1023 is “overlapped”, then a task screening step 2024 is performed.
   3. Task creation assistance step 2023: as shown in FIG. 7, after user finishes the input of the task creation information, the task management module 1023 will save the task creation information of the task stronghold P as a task information D4 which has a task performing place D41, a task difficulty value D42, and a task presence time D43. Furthermore, the task difficulty value D42 can be a fixed value or a non-fixed value. In the present embodiment, the task difficulty value D42 takes a fixed value as example, such as monster blood 100/100. Such as in the task difficulty value D42 shown in the figure, the left value is a variable value which can be changed according to interaction state of user, while the right value is a fixed value given by the task database 102 and the value content can be increased according to the task difficulty level. Moreover, the content of the task information D4 can also include business activity message (not shown in figure), such as store sales message, exhibition activity message, department store anniversary celebration message, group activities, product promotion message. Referring to FIG. 8, after the task management module 1023 generates the task information D4, the task management module 1023 further transmits the task information D4 to the other mobile information device (101′,101″ . . . ) or internet through the task issuing module 1025, so that the other users can check the task information or participate in the performance of the task. Simultaneously, the task management module 1023 will set a task creation assistance time and transmit a co-founding request message 51 to the other mobile information device (101′,101″ . . . ) or internet. When users receive or check the co-founding request message 51 in the internet, users can click a creation assistance option M3 of the service menu M (as shown in FIG. 9), and then the mobile information device 101′ will send a task assistance agreement reply message S2 to the task database 102, wherein the task creation assistance option M3 can also be established on social networking sites, for example facebook fan page or personal dynamic wall. When users search and find relevant activities information of task creation information and press ‘like’, the social networking sites will also transmit the creation assistance option M3 to the task database 102 so that users can form a game community on the social networking sites to increase the degree of interaction between various users. After the task database 102 receives each task assistance agreement reply message S2, the task management module 1023 will calculate the number of the task assistance agreement reply message S2 within the task creation assistance time and set a first threshold value and screening task of the task difficulty value D42 according to the task assistance agreement reply message S2. For example, when the total number of the task assistance agreement reply message S2 is 100, the first threshold value of the task difficulty value D42 is set to be 500. When the total number of the task assistance agreement reply message S2 is 500, the first threshold value of the task difficulty value D42 is set to be 1000, that is to say, the more the total number of the task assistance agreement reply message S2 is taken for the task, the higher the first threshold value of the task difficulty value D42 of the task becomes.
   4. Screening task step 2024: in FIG. 10, there are a first established task stronghold P1 and a new established task stronghold P2, the task trade-off range of the task stronghold P1 is R1 and the task trade-off range of the task stronghold P2 is R1′. As shown in the figure, when the task management module 1023 detects that the task trade-off ranges (R1, R1′) of the two task strongholds (P1, P2) are partially or totally overlapped with each other, the task management module 1023 will issue an range overlapping alarm through the task issuing module 1025 to the mobile information device 101 of the user who creates that task having ranges overlapped. Furthermore, the task management module 1023 will compare a second trade-off parameter of the two tasks and screen out the one with lower second trade-off parameter by deleting or hiding the screened task, wherein the second trade-off parameter may be a total number of interaction of the task assistance agreement reply message S2 of each task, or total number of punch, total number of pressing ‘like’, total number of message, or total number of rating, but is not limited thereto. Moreover, when the second trade-off parameter of the task with task trade-off range being R1 is smaller than the second trade-off parameter of the task with task trade-off range being R1′, the task management module 1023 will delete or hide the task with task trade-off range being R1. On the contrary, when the second trade-off parameter of the task with task trade-off range being R1′ is smaller than the second trade-off parameter of the task with task trade-off range being R1, the task management module 1023 will delete or hide the task with task trade-off range being R1′. Moreover, when the second trade-off parameter of the newly established task is bigger than the second trade-off parameter of the primitive task, the task management module 1023 will issue a task reservation message S3 within a period of time (such as 24 hours), so users can choose whether to reserve that task or not. When the mobile information device (101′,101″ . . . ) receives the task reservation message S3 (as shown in FIG. 8), user can choose whether to reply the task reservation message S3 or not. If user decides to reply the task reservation message S3, the task execution program 1015 will generate a task reserving result message S4 and send it to the task database 102. The task management module 1023 will count the total number of the task reserving result message S4 and weigh the second trade-off parameter of the primitive task. If the weighed second trade-off parameter is larger than the second trade-off parameter of the newly established task, the task management module 1023 will reserve the task information D4 of the primitive task. On the contrary, the task management module 1023 will delete or hide the task information D4 of the primitive task. After the screening task step 2024 is completed, the task creation assistance step 2023 is repeated.
(3). Task execution step 203: FIG. 11 is a detailed flow chart of the task execution step. As shown in this figure, the task execution step 203 includes following steps:
   1. Entering into task execution range to perform the task step 2031: referring to FIG. 12, when another user want to perform the task, he or she can open the task execution program 1015 and call out the task map module 1026 by another mobile information device 101′. This another user can search and find a plurality of task strongholds (P1, P2, P3,,,) on the task map module 1026, and the instantaneous location of the mobile information device 101′ can be displayed on the task map module 1026. Each of the task strongholds (P1, P2, P3,,,) has its own task execution range R2 around the stronghold, and the instantaneous location of the mobile information device 101′ has another task execution range R2′ around the instantaneous location. When performing the task, another user can allow the task stronghold P1 entering into the task execution range R2′ of the mobile information device 101′ by the location of the mobile information device 101′, so that the task stronghold P1 is in a trigger-enabled state. Either user can choose whether to trigger the task of the task stronghold P1 or not, or the mobile information device 101′ can enter into the task execution range R2 of the task stronghold P1, both ways can allow the task stronghold P1 to be in a trigger-enabled state, but is not limited to anyone task triggering mode. Furthermore, when the task at the task stronghold P1 is in a trigger-enabled state, the mobile information device 101′ can click the task stronghold P1 and a task execution option M4 (as shown in FIG. 4) so as to allow the mobile information device 101′ to perform the task. When the mobile information device 101′ is located outside the task execution range R2 and anyone of the task strongholds (P1, P2, P3, . . . ) does not enter into the task execution range R2′ of the mobile information device 101′, the mobile information device 101′ can perform other interaction, such as perform ‘like’ pressing, rating, message directed to each task stronghold (P1, P2), but is not limited thereto.
   2. Select task interaction option step 2032: referring to FIG. 13, when the mobile information device 101′ begins the execution of a task, a task execution screen 1016 will be displayed on the mobile information device 101′, on which a task difficulty value D42, at least one task interaction option (1017, 1017′, 1017″ . . . ), and a user's value 1018 will be shown, wherein the task interaction option (1017, 1017′, 1017″ . . . ) can produce different interactive effect to the task. For example, when user chooses the task interaction option 1017 (normal attack), the task difficulty value D42 will change from 100/100 to 75/100. Alternatively, when user chooses the task interaction option 1017 (claw attack), the task difficulty value D42 will change from 100/100 to 45/100. When the task difficulty value D42 is zero (i.e., 0/100), this user finishes a task and exits from the task execution screen 1016 and returns back to the task map module 1026.
   3. Task feedback step 2033: when user completes interaction, user can get a task reward feedback (such as virtual currency, virtual gemstone or virtual treasure, but is not limited thereto). User can use the task reward feedback in a virtual mall established in the task execution program 1016 to buy props or treasures concerning with other task, such as other task interaction options so as to increase the degree of abundance in task.
(4) Task difficulty lifting step 204: referring to FIG. 14, as described above, when more and more users come into interaction, the task difficulty adjustment module 1027 will determine whether the task has reached a task difficulty lifting condition or not. The above task difficulty lifting condition is established either when the task difficulty value D42 reaches a lower limit value (such as 0% or 10%, and 0% as an example in present embodiment) or when the number of users coming into interaction reaches a target value (such as 500 persons/1000 persons/1500 persons). The task difficulty adjustment module 1027 can adjust the task difficult of the task, or the task difficulty adjustment module 1027 can adjust the task difficulty of the task according to the upgrade of the second trade-off parameter (total number of punch, total number of pressing ‘like’, total number of message, rating), but is not limited thereto. The above task difficulty can be the variation of the task difficulty value D42. For example, the task difficulty adjustment module 1027 can replace the task difficulty value D42 of the task information D4 with an upgrade task difficulty value D42′, wherein the value increased can be summed up according to the proportion of the task difficulty value D42 or can be a fixed value (such as 50, 75, 100). For example, if the task difficulty value D42 is monster blood volume, when the value of the monster blood volume is 0/100, the monster blood volume can be lifted to 150/150 after the task difficulty is lifted, and the task management module 1023 will issue the updated task to the other mobile information device (10140 ,101″,101′″ . . . ) through the task information issuing module 1025. ( [symbol] ) Furthermore, after the task difficulty is lifted, users who create and assist the task creation can get task reward feedback continuously and the task reward feedback after the other users finish the task interaction can also be raised.

Based on foregoing, the present invention is mainly formed by at least one mobile information device and a task database. The mobile information device has downloaded with a task execution program which can be opened by an user so as to click a task creation option or a task execution option. If user wants to create a task, he or she can click the task creation option, and assign a task stronghold on the task map module, and the task scale adjustment module can adjust a task trade-off range of the task stronghold according to a first trade-off parameter of the task stronghold. After the adjustment is completed, the task management module can detect whether the task trade-off range overlaps with the adjacent task trade-off range or not. If the task trade-off range is overlapped, the task management module will compare second trade-off parameters of the two task strongholds, and delete or hide the task stronghold with lower second trade-off parameter. The task creation is completed until the task stronghold does not overlap with the range of the other stronghold. When user want to perform one of the tasks, user can contact with the task stronghold by a task execution range of the mobile information device so as to trigger the task of the task stronghold, or enter into the task execution range of the task stronghold by the instantaneous location of the mobile information device. When user clicks the task execution option of the service menu, the task stronghold can be triggered to perform the task. In this manner, after implementation based on abovementioned, the present invention can indeed achieve the object of providing a system for upgrading and screening of task and its implementing method, wherein the task database can automatically screening two task strongholds having their range overlapped so as to delete or hide the task stronghold with lower task trade-off parameter.

While the present invention has been described by preferred embodiments in conjunction with accompanying drawings, it should be understood that the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

1. A system for upgrading and screening of task, comprising:
at least one mobile information device which has a microprocessing module, and additional has an input module, a data transmitting module, a positioning module and a task execution program in information connection with said microprocessing module, said positioning module being used for locating the position of said mobile information device;
a task execution program preloaded on said mobile information device which is in information connection with said microprocessing module, said task execution program having a service menu for perform registration, creation and execution of a task;
a task database which has a central processing module, and additionally has a task management module, a task issuing module, a task scale adjustment module, and a task map module in information connection with said central processing module; said task map module being able to generate at least one task stronghold which have their respective task trade-off range, said task scale adjustment module being capable of adjusting said task trade-off range of said task stronghold by a first trade-off parameter, said task management module screening two said task strongholds, which have their task trade-off range overlapped with each other, by a second trade-off parameter.

2. The system for upgrading and screening of task as claimed in claim 1, wherein said task database further comprises a task difficulty adjustment module, which is in information connection with said central processing module, for adjusting a task difficulty of said task stronghold.

3. The system for upgrading and screening of task as claimed in claim 1, wherein said task stronghold has at least one task information.

4. The system for upgrading and screening of task as claimed in claim 3, wherein said task information includes a business activities message.

5. The system for upgrading and screening of task as claimed in claim 1, wherein said service menu has a registration option, a task creation option, a task creation assistance option and a task execution option.

6. An implementing method of a system for upgrading and screening of task, comprising:
an user registration step: a task execution program of a mobile information device is opened and a registration option of a service menu is clicked, an user registration information and an user registration location information are inputted and then transmitted and saved in a task database through said mobile information device;
a task creation step: a task creation option of said service menu is clicked; a task stronghold on said task map module is selected and a task creation information on a task management module is inputted; a task scale adjustment module adjusts and sets a task trade-off range of said task stronghold by a task scale adjustment module; said task management module calculates whether said task trade-off range of said task stronghold overlaps with the other task trade-off range of an adjacent task stronghold or not, and said task management module will save said task creation information as an task information if not in overlapping state, or if in overlapping condition, said task management module will makes comparison between the second trade-off parameters of the two overlapping task trade-off ranges and then delete or hide said task stronghold having lower second trade-off parameter;
a task execution step: said task stronghold is triggered by anyone said mobile information device, a task execution option of said service menu is clicked; a task execution screen is displayed on the other said mobile information device; user exits said task execution screen after completing said task and the step returns back to said task map module; and
a task difficulty lifting step: a task difficulty adjustment module determines whether said task of each said task stronghold matches said task difficulty lifting condition or not, if yes, said task difficulty adjustment module will adjust a task difficulty value of said task information on said task stronghold.

7. The implementing method of a system for upgrading and screening of task as claimed in claim 6, wherein said task difficulty lifting condition is based on said second trade-off parameter in such a manner that said task difficulty adjustment module will adjust said task difficulty value of said task stronghold.

8. The implementing method of a system for upgrading and screening of task as claimed in claim 6, wherein said task stronghold is either selected by said task map module or based on a positioning information, or is generated by the combination thereof.

9. The implementing method of a system for upgrading and screening of task as claimed in claim 6, wherein, after said task difficulty adjustment module adjusts said task difficulty value of said task information on said task stronghold, the user creating and assisting the creation of said task can get a reward feedback value which can be weighed according to the proportion of said task difficulty value.

10. The implementing method of a system for upgrading and screening of task as claimed in claim 6, wherein, accompanying with the upgrade of said second trade-off parameter of said task stronghold, the user creating and assisting the creation of said task can get a reward feedback value which can be weighed according to the upgrading proportion of said second trade-off parameter.

11. The implementing method of a system for upgrading and screening of task as claimed in claim 6, wherein the triggering of said task stronghold is said task stronghold becomes a trigger-enabled state after contacting with a task execution range, and said task execution range is formed around the instantaneous location of each said mobile information device.

12. The implementing method of a system for upgrading and screening of task as claimed in claim 6, wherein the triggering of said task stronghold is said task stronghold becomes a trigger-enabled state after contacting with said task execution range, and said task execution range is formed around each said task stronghold.
